(19) United States
(12) Patent Application Publication
(10) Pub. No.: US 2005/0273370 A1
(43) Pub. Date: Dec. 8, 2005

(54) System and method for determining risk management solutions

(75) Inventors: Brian David Udell, Ft. Lauderdale, FL (US); Richard Bernard Welch, Ft. Lauderdale, FL (US); Steven Mark Shapiro, Boca Raton, FL (US)

Correspondence Address: RUDEN, MCCLOSKY, SMITH, SCHUSTER & RUSSELL, P.A., 222 LAKEVIEW AVE, SUITE 800, WEST PALM BEACH, FL, 33401-6112, US

(73) Assignee: Best Practices Medical Partners, LLC

(21) Appl. No.: 11/142,976

(22) Filed: Jun. 2, 2005

Related U.S. Application Data
(60) Provisional application No. 60/576,268, filed on Jun. 2, 2004.
(60) Provisional application No. 60/581,594, filed on Jun. 21, 2004.

(51) Int. Cl. G06F 17/60

(52) U.S. Cl. 705/4

(57) ABSTRACT

A particular healthcare provider's medico-legal risk relative to other healthcare providers practicing in the same field as the particular healthcare provider is determined by: acquiring information about the particular healthcare provider; and processing the acquired information to generate a medico-legal risk score for the particular healthcare provider. The medico-legal risk score generated for the particular healthcare provider may be used by an insurance company to determine whether to provide a malpractice insurance policy to the healthcare provider and/or to determine the amount of a premium for a malpractice insurance policy for the particular healthcare provider. Calculation of the particular healthcare provider's medico-legal risk score is performed using a computer program-implemented algorithm that automatically generates the medical-legal risk score in response to input of information about the particular healthcare provider.

### CROSS-REFERENCE TO RELATED APPLICATIONS

The present application claims the priority of U.S. provisional patent application No. 60/576,268 filed Jun. 2, 2004 and U.S. provisional patent application No. 60/581,594 filed Jun. 21, 2004.

### FIELD OF THE INVENTION

The invention relates generally to the fields of risk management and information technology. More particularly, the invention relates to a system and method for determining the medico-legal risk of a medical care provider.

### BACKGROUND

Insurance companies issue malpractice policies to healthcare providers to insure the healthcare providers against losses arising from malpractice claims. So that an insurance company can both make a profit from its policies and attract new clients with competitive rates, the premium charged for an individual malpractice policy should ideally reflect the actual risk of loss. Accurately evaluating risk is thus a vitally important task for an insurance company.

The risk evaluation process is typically conducted by collecting and analyzing data representing factors affecting the risk associated with a particular type of insurance consumer. Information regarding these factors is collected from an insurance applicant, and that applicant's risk is calculated. Based on the calculated risk, an insurance company decides whether to accept the application and what premium to charge the applicant, if accepted. In the medical malpractice arena, conventional methods for assessing risk involve consideration of only a limited number of factors, e.g., only the applicant's prior claims history, practice area, and practice location.

### SUMMARY

The invention relates to the development of systems and methods for calculating the medico-legal risk that a particular healthcare provider poses to an insurance company relative to that posed by other healthcare providers practicing in the same field as the particular healthcare provider. The particular risk of an individual practitioner can be expressed in terms of a quantitative or otherwise measurable score (a medico-legal risk score) much like those used to rate a consumer's credit risk. The availability of medico-legal risk scores for individual health care practitioners provides insurance companies a rapid, convenient, and easy-to-use method for assisting in the evaluation of the risk of loss associated with any individual healthcare provider. The systems and methods of the invention can be used to supplement standard actuarial practice to more accurately assess the professional malpractice risk associated with a particular healthcare provider/insurance applicant.

Accordingly, the invention features a method for assessing a particular healthcare provider's medico-legal risk relative to other healthcare providers practicing in the same field as the particular healthcare provider. The method includes the steps of: acquiring information about the particular healthcare provider; and processing the acquired information to generate a medico-legal risk score for the particular healthcare provider. The method can further include the steps of: utilizing the generated medico-legal risk score to determine whether to provide a malpractice insurance policy to the particular healthcare provider, and/or utilizing the medico-legal risk score to determine the amount of a premium for a malpractice insurance policy for the particular healthcare provider.

The step of processing the acquired information to generate the medico-legal risk score can be performed using a computer-implemented algorithm. The step of acquiring information about the particular healthcare provider can include acquiring information from the particular healthcare provider and one or more (e.g., one, two, three, or all) people in the following group: patients whom the particular healthcare provider has examined, staff members of the particular healthcare provider's office, peers of the particular healthcare provider's, and staff members of a hospital at which the particular healthcare provider has privileges.

In the foregoing method, the particular healthcare provider can be a physician and the step of acquiring information about the particular healthcare provider can include providing the particular healthcare provider a first questionnaire having therein questions that are not specific to any particular specialized area of medical practice and/or providing the particular healthcare provider a second questionnaire including questions that are specific to a particular medical specialty (e.g., internal medicine, neurology, cardiology, ophthalmology, orthopedic surgery, otolaryngology, pediatric surgery, pediatric medicine, plastic surgery, podiatry, pulmonary medicine, radiology, general surgery, urology, gastroenterology, hematology-oncology, anesthesiology, cardiology, emergency medicine, or obstetrics and gynecology).

The foregoing method can also include processing the acquired information to generate a plurality of scores corresponding to a plurality of medico-legal subcategories, e.g., including at least two medico-legal subcategories selected from adverse drug reactions, consents, coverage, documentation, environment of care, extenders, external resources, follow-up, personality, regulations, responsibility, risk tools, and scope of practice. The plurality of scores corresponding to a plurality of medico-legal subcategories can be used to calculate the medico-legal risk score.

Also within the invention is a method including the step of: utilizing a medico-legal risk score generated for the particular healthcare provider to determine whether to provide a malpractice insurance policy to the healthcare provider, the medical-legal risk score being generated by a method including the steps of: acquiring information about the particular healthcare provider; and processing the acquired information to generate the medico-legal risk score for the particular healthcare provider.

Another method within the invention includes utilizing the medico-legal risk score to determine the amount of a premium for a malpractice insurance policy for the particular healthcare provider, the medical-legal risk score being generated by a method including the steps of: acquiring information about the particular healthcare provider; and processing the acquired information to generate the medico-legal risk score for the particular healthcare provider.

In another aspect, the invention features a computer-readable medium including instructions coded thereon that when executed on a suitably programmed computer executes a step in the method of the invention, e.g., the step of processing the acquired information to generate a medico-legal risk score.

Also within the invention is a system for assessing a particular healthcare provider's medico-legal risk. The system includes: a means for acquiring information about the particular healthcare provider; and a means for processing the acquired information to generate a medico-legal risk score for the particular healthcare provider. In the system of the invention, the means for acquiring information about the particular healthcare provider can include providing questionnaires including questions about the particular healthcare provider to the particular healthcare provider and one or more (e.g., one, two, three, or all) of patients whom the particular healthcare provider has examined, staff members of the particular healthcare provider's office, peers of the particular healthcare provider's, and staff members of a hospital at which the particular healthcare provider has privileges. In addition, in the system, the means for processing the acquired information to generate a medico-legal risk score for the particular healthcare provider can include a computer system running a software program encoding an algorithm for generating the medico-legal risk score from the acquired information.

As used herein, the phrase “edico-legal risk” means the risk that a healthcare provider poses to institutions, patients, insurers and other health care providers by practicing in a more or less accepted and documented fashion.

By the phrase “medico-legal risk score” is meant an identifier or symbol such as an alphanumeric character (e.g., a number) that correlates with a quantity or other measure of medico-legal risk, e.g., 1 TO 10 based on decile of risk; A B C D F; 0-100; 200-800; AAA AA A BBB BB B aaa aa a; ***** **** *** ** *; etc.

By the phrase “a peer of the healthcare provider's” is meant another healthcare provider having the same or similar medical training and credentials as the healthcare provider.

Unless otherwise defined, all technical and legal terms used herein have the same meaning as commonly understood by one of ordinary skill in the art to which this invention belongs. Although methods and materials similar or equivalent to those described herein can be used in the practice or testing of the present invention, suitable methods and materials are described below. All patent applications mentioned herein are incorporated by reference in their entirety. In case of conflict, the present specification, including definitions, will control. In addition, the materials, methods, and examples are illustrative only and not intended to be limiting. Other features and advantages of the invention will be apparent from the following detailed description, and from the claims.

### BRIEF DESCRIPTION OF THE DRAWINGS

FIG. 1 is a flowchart of the system of the invention.

FIG. 2 is a block diagram of the system of the invention.

### DETAILED DESCRIPTION

The invention encompasses systems and methods relating to determining a particular healthcare provider's medico-legal risk relative to other healthcare providers practicing in the same field as the particular healthcare provider. To determine a particular healthcare provider's medico-legal risk, information about the particular practitioner is acquired from the practitioner as well as others with knowledge of the practitioner's personality, professional habits, and abilities, e.g., using a series of questionnaires. The acquired information is then used to calculate a medico-legal score which can be used as a measure of the particular practitioner's medico-legal risk relative to other healthcare providers practicing in the same field as the particular healthcare provider. An insurance company may use the practitioner's medico-legal score to determine whether to issue the practitioner a malpractice insurance policy and/or to determine the appropriate amount of the premium for such a policy.

The below described preferred embodiments illustrate adaptations of these systems and methods. Nonetheless, from the description of these embodiments, other aspects of the invention can be made and/or practiced based on the description provided below.

### Method for Assessing Medico-Legal Risk

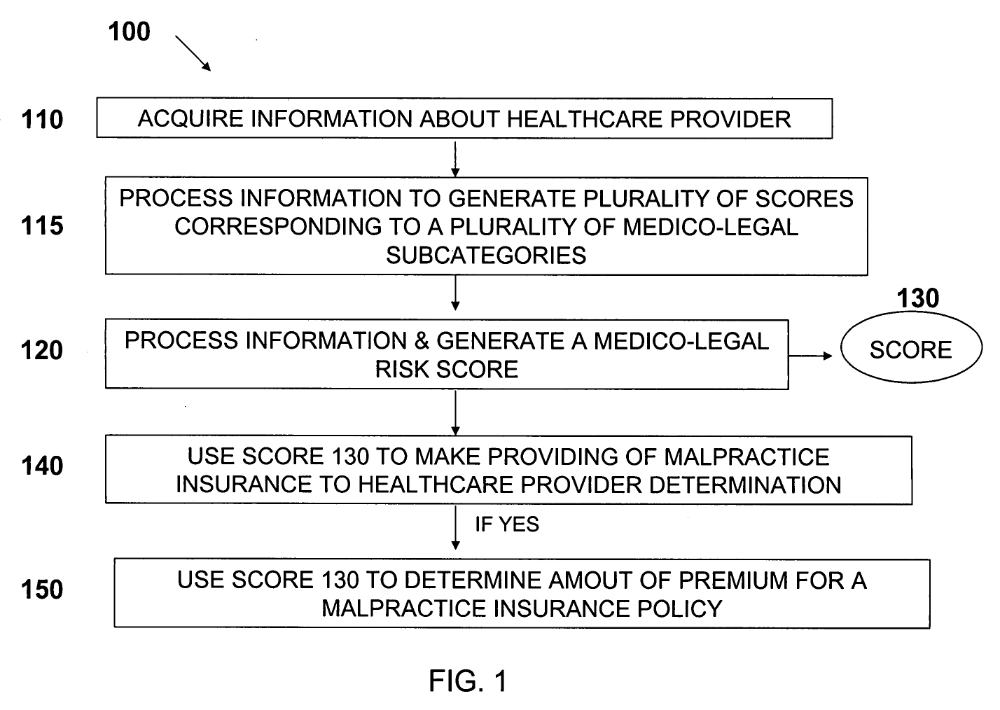

Referring to FIG. 1, a method 100 for assessing a particular healthcare provider's medico-legal risk relative to other healthcare providers practicing in the same field as the particular healthcare provider includes a step 110 of acquiring information about the particular healthcare provider, and a step 120 of processing the acquired information to generate a medico-legal risk score 130 for the particular healthcare provider. In this method, the healthcare provider can be any individual who provides healthcare (e.g., physician, physician's assistant, nurse, nurse practitioner) but is typically a physician.

In a typical embodiment of the method, the step 110 of acquiring information about the particular healthcare provider includes acquiring information from the particular healthcare provider, patients whom the particular healthcare provider has examined, staff members (e.g., medical assistant, nurse, secretary, receptionist, or billing specialist) of the particular healthcare provider's office, peers of the particular healthcare provider's, and/or a staff members (e.g., nurse or technician) of a hospital at which the particular healthcare provider has privileges. Patients from whom information can be obtained include former patients as well as those patients currently receiving care from the healthcare provider. If information is to be obtained from staff members, it is preferred that the staff members are currently employed by the healthcare provider or the hospital at which the particular healthcare provider has privileges. Similarly, if information is to be obtained from a peer of the healthcare provider's, it is preferred that the individual is a current peer of the healthcare provider's.

In some embodiments of the invention, the step 110 of acquiring information about the particular healthcare provider includes providing the healthcare provider a first questionnaire (e.g., a printed or electronic set of questions) composed of questions that are not specific to any single specialized area of medical practice. For ease of scoring, the questions are typically in a multiple choice format, although any format can be used to present the questions. Examples of multiple choice questions that might be present on the first questionnaire include: (1) When a patient is angry, the BEST response is to . . . ?; (2) All of the following statements made during informed consent are appropriate EXCEPT . . . ?; (3) All of the following are important regarding managed care referrals EXCEPT . . . ?; and (4) Accurate, and thorough documentation in the medical record can . . . ?

If the healthcare provider is a physician who practices in a medical specialty, the step 110 of acquiring information about the particular healthcare provider might further include providing the physician a second questionnaire having questions that are specific to the medical specialty. As one example, if the physician specializes in gastroenterology, the second questionnaire may be composed of an assortment of multiple choice questions specific to gastroenterology, especially those relating to legal liability issues that are commonly encountered in the practice of gastroenterology. An example of such question is: “All of the following are common regarding diagnostic errors in gastroenterology EXCEPT . . . ?” Any questions that can be used to assess a healthcare provider's risk behavior are useful in the invention. Specialty-specific questionnaires can be given to a physician practicing in any specialty. Medical specialties include but are not limited to: internal medicine, neurology, cardiology, ophthalmology, orthopedic surgery, otolaryngology, pediatric surgery, pediatric medicine, plastic surgery, podiatry, pulmonary medicine, radiology, general surgery, urology, gastroenterology, hematology-oncology, anesthesiology, cardiology, emergency medicine, and obstetrics and gynecology.

The step 120 of processing the acquired information to generate a medico-legal risk score for the particular healthcare provider is typically performed using a computer-implemented algorithm. In this embodiment, data from the one or more questionnaires for the particular healthcare provider are inputted into a computer running a program implementing the algorithm. The algorithm processes the inputted data to yield one or more risk scores (e.g., a single medico-legal risk score and/or risk scores for subcategories of medico-legal risk) which can be compared through various statistical analyses to the average population score. The risk score for a particular physician can thus be one that is relative to the risks posed by other healthcare providers practicing in the same field as the particular healthcare provider. For example, if the healthcare provider is a physician practicing in obstetrics, the physician's risk score can be relative to risk scores determined for other obstetricians.

In various embodiments of the invention, the method 100 can further include a step 115 of using the information obtained from the healthcare provider to generate a plurality of scores corresponding to the provider's relative medico-legal risk in a plurality of medico-legal subcategories. These plurality of scores corresponding to a plurality of medico-legal subcategories can be used to calculate a healthcare provider's medico-legal risk score. Examples of medico-legal subcategories include: adverse drug reactions (the ability of the healthcare provider to adequately recognize and treat any and all patient reactions and cross-reactions to medications supplied by the healthcare provider or those which a patient may be taking and has provided that information to the provider), consents (the knowledge of the correct usage of patient consent forms and the demonstration that correct protocols are being followed), coverage (who provides on-call coverage for the provider and the process by which information is transferred), documentation (the quantity, quality and consistency of all notes and correspondence), environment of care (the state of the providers' orderliness, the quality of the office and staff, and the perception of the practice by outsiders), extenders (the use of any and all physician extenders—physician's assistants, nurse practitioners, nursing and all other staff and the correct training, documentation and management of such personnel), external resources (the knowledge of, and use of outside systems to help manage the office and patient care referrals), follow-up (how the provider perceives and provides on-going patient responsibility and what is done to assure that services are documented), personality, regulations (how well the provider is aware of any and all regulations about the practice, how well that knowledge is kept current, and how that is documented), responsibility (how much attention the provider takes in assuring that individual responsibility for patient care is imparted to the patient, and what services are provided to demonstrate that care), risk tools (knowledge and usage of outside services and products which, when used properly, increase patient safety and decrease the risk of adverse events), and scope of practice (the size of the practice, the nature of the provider's work, and the demonstration of expert knowledge in their field).

### Questions and Scoring

The questions included on the questionnaire used to obtain information about a healthcare provider can be obtained from any suitable source. Typically, they are obtained from publications or associations (e.g., associations regulating medical specialties) showing that the answers to such questions are correlated with or predictive of a medico-legal risk. The value of any individual question can be assessed by regression analysis at anytime subsequent to implementation of the invention, e.g., answers to the question from a multitude of healthcare providers are compared to liability events occurring in that population of providers 1, 2, 3, 4, 5, 10, and 20 years after answers to the questions are obtained.

Any suitable method of processing input data to arrive at a score that correlates with or is predictive of medico-legal risk might be used in the invention. In a representative embodiment, answers to questions obtained from one or more questionnaires are processed by assigning significance of the question to only a subset of medico-legal subcategories being assessed. For each incorrect answer, a point is assigned to each of the significant medico-legal subcategories. Thus, an incorrect answer will often lead to assignment of 2 or more points to the medico-legal risk score being determined. The scoring aspect of the invention might involve the calculation of a raw score (the number of wrong answers that applied to all subcategories) and/or a calculated score (the number of wrong answers in a subcategory as a percentage of the total possible answers for that category).

In embodiments involving the generation of a plurality of scores corresponding to a plurality of medico-legal subcategories, the medico-legal risk score can be the summation of the weighted medico-legal risk subcategory scores. Risk subcategories can be based on relevance to the medical specialty. Once a risk score is generated, this score is compared through various statistical analyses to the average population score. Regression analyses can be used to determine correlations between the risk score and risk events for the insured healthcare provider. The risk factors are preferably adjusted on an ongoing basis to continuously improve statistical significance. This can be done by an appropriate administrative and/or overseeing entity. One example of an appropriate administrative entity is a multi-member medical advisory panel under the direction of a specialty medical director. Such an entity can conduct peer reviews, analyze physician risk behavior through individual physician impact reports, review current, national specialty specific risk reduction strategies, provide targeted risk reduction process improvement recommendations, and review claims against physicians for merit and potential liability.

### Use of Scores

In various embodiments of the invention, referring again to FIG. 1, a method 100 for assessing a particular healthcare provider's medico-legal risk relative to other healthcare providers practicing in the same field as the particular healthcare provider includes a step 140 of utilizing the generated medico-legal risk score 130 to determine whether to provide a malpractice insurance policy to the particular healthcare provider, and/or a step 150 of utilizing the generated medico-legal risk score 130 to determine the amount of a premium for a malpractice insurance policy for the particular healthcare provider. The step 140 of utilizing the generated medico-legal risk score 130 to determine whether to provide a malpractice insurance policy to the particular healthcare provider involves an insurance company assessing an insurance applicant's medico-legal risk score generated by the methods described above. For example, an insurance company might only desire to offer malpractice policies to healthcare providers that are in the lowest 10% of medico-legal risk relative to other providers in the same area of practice. In the same manner, an insurance company might only desire to offer malpractice policies to healthcare providers that are in the 20-50% bracket of medico-legal risk relative to other providers in the same area of practice. If a determination is made to provide a malpractice insurance policy to a healthcare provider, the amount of the premium for that policy can be set in accordance with a given medico-legal risk score. For example, a radiologist scoring in the lowest 10% of medico-legal risk relative to other providers in the same area of practice might be offered a policy for $20,000 per year, while a radiologist scoring in the 20-50% bracket of medico-legal risk relative to other providers in the same area of practice might be offered a policy for $40,000 per year.

The system and methods of the invention can be used to supplement standard actuarial practice by determining specific risk relativities within a given population so that risk reduction initiatives may be directed to those areas with the greatest potential return. The system and methods of the invention provide for the determination of risk scores by an entity operating the system and methods of the invention as well as risk score determination by an insurance company.

### System for Assessing Medico-Legal Risk

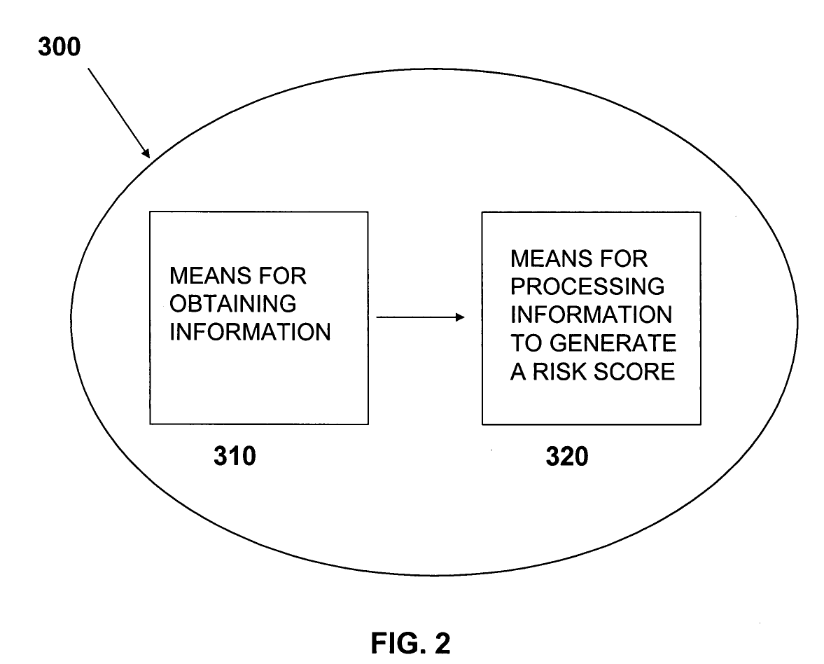

Within the invention is a system 300 for assessing a particular healthcare provider's medico-legal risk relative to other healthcare providers practicing in the same field as the particular healthcare provider. Referring to FIG. 2, the system includes a means 310 for acquiring information about the particular healthcare provider, and a means 320 for processing the acquired information to generate a medico-legal risk score for the particular healthcare provider. The means 310 for acquiring information about the particular healthcare provider can include providing questionnaires having questions about the particular healthcare provider to the particular healthcare provider and one or more people from the following group: a patient whom the particular healthcare provider has examined, a staff member of the particular healthcare provider's office, a peer of the particular healthcare provider's, and a staff member of a hospital at which the particular healthcare provider has privileges.

The means 320 for processing the acquired information to generate a medico-legal risk score for the particular healthcare provider can include a computer system running a software program encoding an algorithm for generating the medico-legal risk score from the acquired information. The system 300 can also include a database for storing traditional insurance data as well as data related to medico-legal issues. The database is useful for recording activity reflecting the behavior of medical personnel in order to highlight opportunities to reduce medico-legal risk. The database of the system 300 is capable of receiving information (e.g., underwriting information, premium information, claims data, etc.) from external sources. The database can be protected by a fire wall, and can have additional storage with back-up capabilities. In preferred embodiments, the database is continuously updated, is user-configurable, and is maintained by appropriate administrative personnel. In a typical embodiment, the appropriate administrative personnel input the data into the database and check the inputted data for errors. The system can also include an interactive information technology system which provides enterprise support as well as local interactive education and monitoring of the healthcare providers who are insured for medical malpractice.

### Computer-Readable Medium

The methods and systems of the invention can be implemented using a computer equipped with executable software to automate some of the methods described herein. Accordingly, various embodiments of the invention include a computer-readable medium having instructions coded thereon that, when executed on a suitably programmed computer, execute one or more steps involved in the method of the invention, e.g., a step of processing information acquired about a healthcare provider to generate a medico-legal risk score. Examples of suitable such media include any type of data storage disk including a floppy disk, an optical disk, a CD-ROM disk, a DVD disk, a magnetic-optical disk; read-only memories (ROMs); random access memories (RAMs); electrically programmable read-only memories (EPROMs); electrically erasable and programmable read only memories (EEPROMs); magnetic or optical cards; or any other type of medium suitable for storing electronic instructions, and capable of being coupled to a system for a computing device.

### Other Embodiments

While the above description contains many specifics, these should not be construed as limitations on the scope of the invention, but rather as examples of preferred embodiments thereof. Many other variations are possible. Accordingly, the scope of the invention should be determined not by the embodiments illustrated, but by the appended claims and their legal equivalents.

1. A method for assessing a particular healthcare provider's medico-legal risk relative to other healthcare providers practicing in the same field as the particular healthcare provider, the method comprising the steps of:
acquiring information about the particular healthcare provider; and
processing the acquired information to generate a medico-legal risk score for the particular healthcare provider.

2. The method of claim 1, further comprising the step of: utilizing the generated medico-legal risk score to determine whether to provide a malpractice insurance policy to the particular healthcare provider.

3. The method of claim 1, further comprising the step of: utilizing the generated medico-legal risk score to determine the amount of a premium for a malpractice insurance policy for the particular healthcare provider.

4. The method of claim 1, wherein the step of processing the acquired information to generate the medico-legal risk score is performed using a computer-implemented algorithm.

5. The method of claim 1, wherein the step of acquiring information about the particular healthcare provider comprises acquiring information from the particular healthcare provider and at least two people selected from the group consisting of: a patient whom the particular healthcare provider has examined, a staff member of the particular healthcare provider's office, a peer of the particular healthcare provider's, and a staff member of a hospital at which the particular healthcare provider has privileges.

6. The method of claim 1, wherein the step of acquiring information about the particular healthcare provider comprises acquiring information from the healthcare provider and at least three people selected from the group consisting of: a patient whom the particular healthcare provider has examined, a staff member of the particular healthcare provider's office, a peer of the particular healthcare provider's, and a staff member of a hospital at which the particular healthcare provider has privileges.

7. The method of claim 1, wherein the step of acquiring information about the particular healthcare provider comprises acquiring information from the particular healthcare provider, a patient whom the particular healthcare provider has examined, a staff member of the particular healthcare provider's office, a peer of the particular healthcare provider's, and a staff member of a hospital at which the particular healthcare provider has privileges.

8. The method of claim 1, wherein the particular healthcare provider is a physician and the step of acquiring information about the particular healthcare provider comprises providing the healthcare provider a first questionnaire consisting essentially of questions that are not specific to any single specialized area of medical practice.

9. The method of claim 8, wherein the physician practices in a medical specialty, and the method further comprises providing the particular healthcare provider a second questionnaire comprising questions that are specific to the medical specialty.

10. The method of claim 9, wherein the medical specialty is selected from the group consisting of: internal medicine, neurology, cardiology, ophthalmology, orthopedic surgery, otolaryngology, pediatric surgery, pediatric medicine, plastic surgery, podiatry, pulmonary medicine, radiology, general surgery, urology, gastroenterology, hematology-oncology, anesthesiology, cardiology, emergency medicine, and obstetrics and gynecology.

11. The method of claim 1, further comprising the step of: processing the acquired information to generate a plurality of scores corresponding to a plurality of medico-legal subcategories.

12. The method of claim 11, wherein the plurality of medico-legal subcategories comprises at least two medico-legal subcategories selected from the group consisting of: adverse drug reactions, consents, coverage, documentation, environment of care, extenders, external resources, follow-up, personality, regulations, responsibility, risk tools, and scope of practice.

13. The method of claim 11, wherein the plurality of scores corresponding to a plurality of medico-legal subcategories is used to calculate the medico-legal risk score.

14. A method for assessing a particular healthcare provider's medico-legal risk relative to other healthcare providers practicing in the same field as the particular healthcare provider, the method comprising the step of: utilizing a medico-legal risk score generated for the particular healthcare provider to determine whether to provide a malpractice insurance policy to the healthcare provider, the medical-legal risk score being generated by a method comprising the steps of: acquiring information about the particular healthcare provider; and processing the acquired information to generate the medico-legal risk score for the particular healthcare provider.

15. A method for assessing a particular healthcare provider's medico-legal risk relative to other healthcare providers practicing in the same field as the particular healthcare provider, the method comprising the step of: utilizing the medico-legal risk score to determine the amount of a premium for a malpractice insurance policy for the particular healthcare provider, the medical-legal risk score being generated by a method comprising the steps of: acquiring information about the particular healthcare provider; and processing the acquired information to generate the medico-legal risk score for the particular healthcare provider.

16. A computer-readable medium comprising instructions coded thereon that, when executed on a suitably programmed computer, execute the step of processing the acquired information to generate a medico-legal risk score in a method for assessing a particular healthcare provider's medico-legal risk relative to other healthcare providers practicing in the same field as the particular healthcare provider, the method comprising the steps of: acquiring information about a healthcare provider; and processing the acquired information to generate a medico-legal risk score for the healthcare provider.

17. A system for assessing a particular healthcare provider's medico-legal risk relative to other healthcare providers practicing in the same field as the particular healthcare provider, the system comprising:
a means for acquiring information about the particular healthcare provider; and
a means for processing the acquired information to generate a medico-legal risk score for the particular healthcare provider.

18. The system of claim 17, wherein the means for acquiring information about the particular healthcare provider comprises providing questionnaires comprising questions about the particular healthcare provider to the particular healthcare provider and at least two people selected from the group consisting of: a patient whom the particular healthcare provider has examined, a staff member of the particular healthcare provider's office, a peer of the particular healthcare provider's, and a staff member of a hospital at which the particular healthcare provider has privileges.

19. The system of claim 17, wherein the means for acquiring information about the particular healthcare provider comprises providing questionnaires comprising questions about the particular healthcare provider to the healthcare provider and at least three people selected from the group consisting of: a patient whom the particular healthcare provider has examined, a staff member of the particular healthcare provider's office, a peer of the particular healthcare provider's, and a staff member of a hospital at which the particular healthcare provider has privileges.

20. The system of claim 17, wherein the means for processing the acquired information to generate a medico-legal risk score for the particular healthcare provider comprises a computer system running a software program encoding an algorithm for generating the medico-legal risk score from the acquired information.
